(19) United States
(12) Patent Application Publication
(10) Pub. No.: US 2011/0128515 A1
(43) Pub. Date: Jun. 2, 2011

(54) LITHOGRAPHIC APPARATUS AND SEALING DEVICE FOR A LITHOGRAPHIC APPARATUS

(75) Inventor: Johannes MAQUINÉ, Eindhoven (NL)

(73) Assignee: ASML NETHERLANDS B.V., Veldhoven (NL)

(21) Appl. No.: 12/953,027

(22) Filed: Nov. 23, 2010

Related U.S. Application Data
(60) Provisional application No. 61/265,902, filed on Dec. 2, 2009.

(51) Int. Cl. G03B 27/52; F16J 15/44; F16J 15/16

(52) U.S. Cl. 355/30; 277/409; 277/300

(57) ABSTRACT

An apparatus includes a first body; a second body that is moveable relative to the first body; a seal arranged between the first and the second body such that a first space is separated from a second space by the first body, the second body and the seal, wherein the seal is located at a distance from the first body; a fluid supply arranged to create a fluid flow between the first body and the seal to create a non-contact seal between the first and the second space so as to enable movement between the first and the second body, and a controller configured to control the distance during movement of the first and the second body relative to each other.

### CROSS REFERENCE TO RELATED APPLICATIONS

This application claims priority and benefit under 35 U.S.C. §119(e) to U.S. Provisional Patent Application No. 61/265,902, entitled “Lithographic Apparatus and Sealing Device For A Lithographic Apparatus”, filed on Dec. 2, 2009. The content of that application is incorporated herein in its entirety by reference.

### FIELD

The invention relates to a lithographic apparatus and a sealing device for a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

An apparatus that includes a sealing device (broadly termed a “seal”) is known from U.S. Pat. No. 6,603,130 B1. U.S. Pat. No. 6,603,130 discloses an object table that is contained within a vacuum chamber and is moveable about on the floor of the vacuum chamber by a positioning component. The apparatus includes a first body, a second body that is moveable relative to the first body, and a seal arranged between the first and second body. To enable movement of the object table, the object table is supported above the floor of the vacuum chamber by a gas bearing which surrounds the entire periphery of the object table. Gas is provided to a high pressure area to form the bearing. Some gas will flow outwardly from the high pressure area and is drawn into an evacuation groove and in this way the residual gas flow into the vacuum chamber is kept within acceptable limits.

With this apparatus, when the first and second bodies move relative to each other, for example when they tilt relative to each other, they may come into direct contact. This may lead to damage of the bodies, such as scratches. Scratches may undesirably alter the flow resistance for the fluid flow between the two bodies, and in this way deteriorate the performance of the seal.

### SUMMARY

In an aspect of the invention, there is provided an apparatus that has an improved sealing performance. In one embodiment, this is achieved by an apparatus that includes a controller configured to control the distance during movement of the bodies relative to each other.

In an embodiment of the invention, the apparatus includes a first body; a second body that is moveable relative to the first body; a seal arranged between the first and the second body such that a first space is separated from a second space by the first body, the second body and the seal, wherein the seal is located at a distance from the first body; a fluid supply arranged to create a fluid flow between the first body and the seal to create a non-contact seal between the first and the second space so as to enable movement between the first and the second body, and a controller configured to control the distance during movement of the first and the second body relative to each other.

By controlling the distance during movement of the bodies relative to each other, the distance may be adjusted when the two bodies move too close to each other. This may prevent the bodies from contacting each other and thus may prevent scratches. In case the bodies move too far away from each other, the distance may be made smaller to maintain a good sealing performance. This way the sealing performance of the apparatus is improved.

In an embodiment of the invention, the apparatus includes a fluid extractor configured to extract at least part of the fluid flow provided between the first body and the seal. This is beneficial as it reduces the amount of fluid entering the first or second space or both.

In an embodiment of the invention, the controller includes a flexible element connected between the seal and the second body, configured to change a distance in dependency of the fluid flow. This has the benefit that in case the fluid flow changes because of movement of the bodies, the distance is automatically adjusted.

In an embodiment of the invention the apparatus, the flexible element is adjacent to the fluid extractor.

In an embodiment of the invention the apparatus, the fluid extractor is between the second space and the fluid supply. This has the benefit that the amount of fluid flow from the fluid supply to the second space is reduced.

In an embodiment of the invention the apparatus, the second space comprises less contamination than the first space.

In an embodiment of the invention the apparatus, the first space includes a bearing configured to at least partly constrain the first body with respect to the second body. This has the benefit that a bearing can be used that may not be used in the second space. For example, the bearing may be a simple roller bearing that is configured to generate too much contaminating particles for use in the second space.

In an embodiment of the invention the apparatus, the first space includes hydrocarbons. This has the benefit that, for example, lubricants such as grease and oil may be used in the first space, which may not be used in the second space.

In an embodiment of the invention the apparatus, the first body is rotatable relative to the second body.

In an embodiment of the invention, in use, the first and second spaces are at a pressure that is lower than the atmospheric pressure. This has the benefit that the apparatus can be used in processes that take place at a pressure that is lower than the atmospheric pressure. By having both the spaces at a pressure lower than the atmospheric pressure, a large pressure difference is prevented.

In an embodiment of the invention, in use, the first space is at a pressure between about 0-30 mbar, for example between about 1-23 mbar.

In an embodiment of the invention, in use, the second space is at a pressure of about 0-0.5 mbar.

In an embodiment of the invention, the distance is in the range of about 10-70 μm, for example 15, 20 or 50 μm. This has the benefit that the distance is large enough to prevent contact between the first body and the sealing device and this way scratches are prevented. It also has the benefit that the distance is small enough to provide enough flow resistance to limit the amount of flow needed to seal the two spaces.

In an embodiment of the invention, the fluid flow includes nitrogen.

In an embodiment of the invention, the apparatus is a handler configured to move an object between a loading station to a stage of a lithographic apparatus.

In an aspect of the invention, there is provided a lithographic apparatus including a patterning device support configured to support a patterning device, the patterning device being capable of patterning a beam of radiation to provide a patterned beam of radiation; a substrate support configured to hold a substrate; a projection system configured to project the patterned beam of radiation onto the substrate, and an apparatus including a first body; a second body that is moveable relative to the first body; a seal arranged between the first and the second body such that a first space is separated from a second space by the first body, the second body and the seal, wherein the seal is located at a distance from the first body; a fluid supply arranged to create a fluid flow between the first body and the seal to create a non-contact seal between the first and the second space so as to enable movement between the first and the second body, and a controller configured to control the distance during movement of the first and the second body relative to each other.

In an aspect of the invention, there is provided a method including providing a first body, providing a second body that is moveable relative to the first body; providing a seal arranged between the first and the second body such that a first space is separated from a second space by the first body, the second body and the seal, reducing the pressure of the first space and the second space wherein the pressure of the first space is maintained at a lower value than the second space.

### BRIEF DESCRIPTION OF THE DRAWINGS

Embodiments of the invention will now be described with reference to the accompanying drawings. In these drawings:

FIG. 1 schematically depicts a lithographic apparatus according to an embodiment of the invention;

FIG. 2 shows a cross-section of an apparatus including a seal according to an embodiment of the invention; and

FIG. 3 shows a handler configured to handle an object in a lithographic apparatus in accordance with an embodiment of the invention.

### DETAILED DESCRIPTION

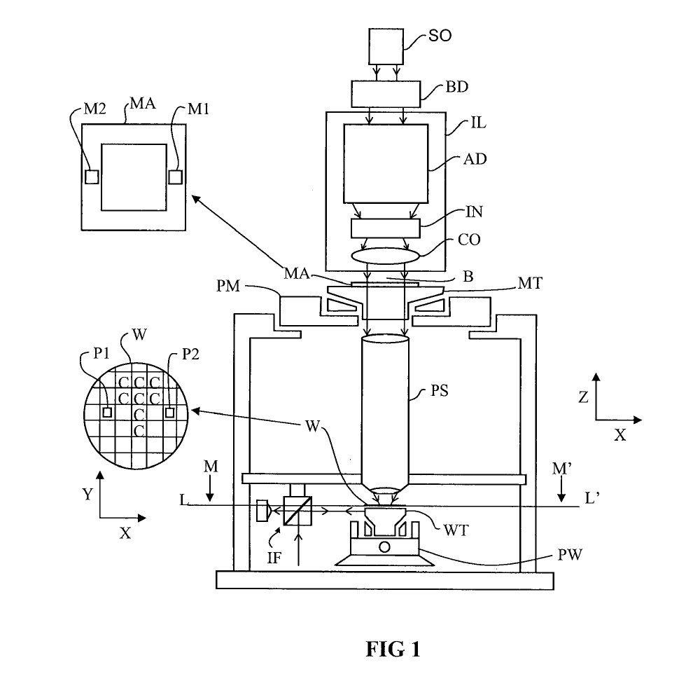

FIG. 1 schematically depicts a lithographic apparatus according to one embodiment of the invention. The apparatus includes:

an illumination system (illuminator) IL configured to condition a radiation beam B (e.g. UV radiation or DUV radiation).

a patterning device support or support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, to direct, shape, or control radiation.

The patterning device support holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support may be a frame or a table, for example, which may be fixed or movable as required. The patterning device support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross section.

The radiation beam B is incident on the patterning device (e.g., mask) MA, which is held on the patterning device support (e.g., mask table) MT, and is patterned by the patterning device. Having traversed the patterning device (e.g. mask) MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the patterning device support (e.g. mask table) MT may be realized with the aid of a long stroke module (coarse positioning) and a short stroke module (fine positioning), which form part of the first positioner PM. Similarly, movement of the substrate table WT may be realized using a long stroke module and a short stroke module, which forms part of the second positioner PW. In the case of a stepper (as opposed to a scanner) the patterning device support (e.g. mask table) MT may be connected to a short-stroke actuator only, or may be fixed. Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g. mask) MA, the patterning device alignment marks may be located between the dies.

The depicted apparatus could be used in at least one of the following modes:

1. In step mode, the patterning device support (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the patterning device support (e.g. mask table) MT and the substrate table WT are scanned synchronously while a pattern imparted to the radiation beam is projected onto a target portion C (i.e. a single dynamic exposure). The velocity and direction of the substrate table WT relative to the patterning device support (e.g. mask table) MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the patterning device support (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

Combinations and/or variations on the above described modes of use or entirely different modes of use may also be employed.

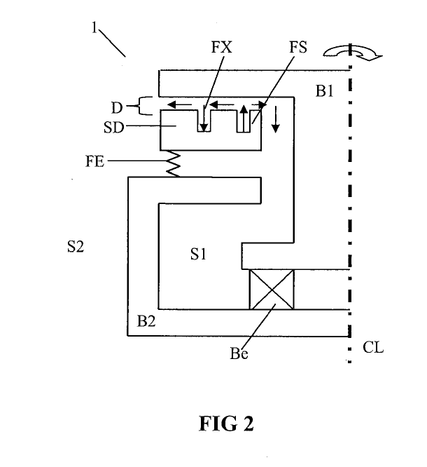

FIG. 2 shows half a cross-section of an apparatus 1 according to an embodiment of the invention. FIG. 2 shows an apparatus including a first body B1 and a second body B2 that is moveable relative to the first body B1. The apparatus also includes a seal SD arranged between the first B1 and second body B2 such that a first space S1 is separated from a second space S2 by the first body B1, the second body B2 and the seal SD. The seal SD is located at a distance D from the first body B1. The apparatus 1 is provided with a fluid supply FS arranged to create a fluid flow between the first body B1 and the seal SD to create a non-contact seal between the spaces that is configured to enable movement between the bodies. The apparatus 1 may further include a controller FE to control the distance D during movement of the bodies relative to each other.

In an embodiment, the first and second bodies are parts of a lithographic apparatus. For example, the first and/or the second body can be part of the housing of a lithographic apparatus. Alternatively, or in addition, the first and the second body can be arranged within the housing of the lithographic apparatus.

In the embodiment of FIG. 2, the first body B1 is rotatably moveable relative to the second body B2 along center line CL. Alternatively or additionally, the first body B1 may be moveable in other directions, for example translatable along the center line CL or in other directions, rotatable in other directions that along the center line CL or combinations of these directions.

In the embodiment of FIG. 2, the seal SD is between the first body B1 and the second body B2. The two bodies and the seal SD form a barrier between a first space S1 and a second space S2. In this embodiment the first space may be referred to as being inside the apparatus 1. The second space may be considered to be outside the apparatus 1. Alternatively, one of bodies B1 and B2 may substantially enclose the other of bodies B1 and B2. In that case, both spaces may be considered to be inside the apparatus.

It will be appreciated that the spaces S1 and S2 are not completely separated from each other, as there is a connection between the first body B1 and the seal SD, connecting both spaces. This connection is created because the seal is located at a distance D from the first body B1. As a result of the distance D, there is no direct mechanical contact between the first body B1 and the seal SD. As a result, when the two bodies move relative to each other, there is no friction between the first body B1 and the seal SD. This may prevent wear and production of contaminating particles.

If contaminating particles are created, they may enter one or both of the two spaces. Depending on the components that are inside the two spaces, and the processes that take place, contaminating particles may deteriorate the performance of those components and processes. For example, a lithographic process may take place in the second space S2. Particles entering the second space S2, may contaminate a substrate W that is located in the second space S2. A projection system PS may be in the second space. Particles may become attached to the projection system PS and deteriorate the quality of the radiation beam B passing through the projection system PS.

FIG. 2 further depicts a fluid supply FS arranged to create a fluid flow between the first body B1 and the sealing device SD. The fluid flow generates a pressure between the first body B1 and the seal SD. The pressure creates a force that increases the distance D by pushing the first body B1 and the seal SD away from each other.

To control the distance D, the apparatus 1 is provided with a controller. In the embodiment of FIG. 2, the controller includes a flexible element FE, e.g. a spring. When the distance D becomes larger because of the fluid flow, the flexible element becomes more compressed and generates a force to decrease distance D. In a stationary situation, the forces of the fluid flow and the flexible element FE are equally large, and as a result distance D is substantially constant.

In an embodiment the controller includes a sensor. The sensor may be configured to measure the distance D. Alternatively, the sensor may measure the amount of fluid flow, or the pressure of the fluid flow between the first body B1 and the seal SD. The sensor may produce a signal to control an actuator that moves the seal SD relative to the first body B1 to change distance D.

The fluid flow from the fluid supply FS creates a non-contact seal between the spaces. The fluid flow is directed away from the fluid supply FS and toward the two spaces. Fluids and particles in one of the two spaces are not able to pass the fluid supply, as they are pushed back by the fluid flow from the fluid supply FS. As no fluids and particles are able to transfer from one space to another, the two spaces are sealed from each other. By creating a film of fluid, the fluid flow prevents mechanical contact between the first body B1 and the seal SD. This way a non-contact seal is created.

As the fluid flow from the fluid supply FS may enter the two spaces, it is beneficial to use a fluid that does not negatively influence components or processes in the two spaces. A dry gas may be used that contains no water or has a low concentration of water. Water may cause contamination on components in the two spaces, and may cause oxidation. An inert gas may be used, to prevent an undesired chemical interaction between the fluid flow and the components in the two spaces. The fluid flow may comprise nitrogen (N₂). Nitrogen is a commonly available inert gas and may be used in a lithographic apparatus, as it may be inert with respect to components of the projection system PS.

In the embodiment of FIG. 2, the fluid supply FS is connected to the seal SD. Alternatively or additionally, the fluid supply FS is connected to the first body B1. The fluid supply FS may also be connected to a further body.

To reduce the amount of fluid flow from the fluid supply FS entering the two spaces, a fluid extractor FX may be used in an embodiment. A non-contact seal can be created using only a certain area. Outside this area, the fluid flow may be extracted by the fluid extractor FX. The fluid extractor FX may be connected to a vacuum source that creates a pressure in the fluid extractor FX that is lower than the pressure of the fluid flow between the first body B1 and the sealing device SD. This way, the fluid flow may be sucked into the fluid extractor FX.

In the embodiment of FIG. 2, the fluid extractor FX is located between the fluid supply FS and the second space S2, to reduce the amount of fluid flow entering the second space S2. Alternatively or additionally, a fluid extractor FX is located between the fluid supply FS and the first space S1. The fluid extractor FX may be connected to the first body B1, the seal SD, a further body or in a combination

In the embodiment of FIG. 2, the flexible element FE separates the two spaces. Alternatively, the flexible element FE is in one of the two spaces.

As the two spaces are sealed from each other, it is possible that each of the two spaces each has its own environment. In an embodiment, the first space S1 includes a dirty environment, whereas the second space S2 includes a clean environment. The second space S2 includes less contamination that the first space S1. For example, in the second space S2 a lithographic process may take place. As contaminating particles may deteriorate the lithographic process, cleanliness is important. Contaminants such as, for example, hydrocarbons (CₓH_{y}) or water (H₂O) may adhere to the optical components of the projection lens PS or may absorb part of the radiation beam B.

In the dirty environment of the first space S1, the creation of particles may be allowed. The first space S1 can, for example, house a bearing Be to at least partly constrain the first body B1 with respect to the second body B2. A bearing that generates particles may be chosen, as it does not contaminate the clean environment in the second space S2. Any suited bearing may be used, such as a ceramic bearing or a roller bearing. Lubricants may be used to reduce the friction between the moving parts of the bearing. Lubricants usually include hydrocarbons, so they are often not suited for use in a lithographic process.

The first space S1 may house all sorts of wires and hoses, for example needed for an actuator connected to the first body B1. While moving the first body B1 relative to the second body B2, the wires and hoses may rub against each other or against other parts of the apparatus. This may create particles, but this does not deteriorate the cleanliness of the second space S2.

In an embodiment, the second space S2 is at a pressure that is lower than the atmospheric pressure, for example in a range between 0-0.5 mbar, for example about 0.01 mbar. This may be beneficial for, for example, a lithographic process in which the radiation B is easily absorbed by matter that comes into the path of the radiation beam B. For example, radiation with a small wavelength, such as Extreme Ultra Violet-radiation or EUV-radiation, is easily absorbed.

To reduce the pressure difference between the two spaces, the first space S1 may also be at a pressure that is lower than the atmospheric pressure, for example between about 0-30 mbar or for example between about 1-23 mbar. A pressure value of the first space S1 may be chosen that is easily achieved and reduces the pressure difference to an acceptable level. Decreasing a pressure value becomes increasingly more difficult. A reduced pressure difference, allows a reduced fluid flow needed from the fluid supply FS, as the fluid flow needs to create a pressure between the first body B1 and the seal SD that is larger than the pressures in the two spaces. A pressure of the fluid flow may be 500 mbar.

In case the first body B1 is moved relative to the second body B2, it is possible that the distance D changes. This may be caused by an inaccuracy of the bearing Be, resulting a wobble motion of the first body B1. The distance D may also change due to a force that is applied to one of the two bodies.

If the distance D for example is decreased, the fluid flow flows less easily between the first body B1 and the seal SD. For a constant flow, this increases the pressure in the fluid flow. As a result of the increased pressure, there is created a larger force pushing the first body B1 and the seal SD away from each other. The flexible element is further compressed, until there is a new equilibrium between the pressure of the fluid flow and the force of the flexible element. This way, the seal SD is able to maintain the distance D in a desired range, and thus mechanical contact between the first body B1 and the seal SD is prevented.

If the distance D for example is increased, the fluid flow flows more easily and the pressure between the first body B1 and the sealing device is decreased. The compressed flexible element is then able to push the sealing device towards the first body B1 until there is a new equilibrium. This way a proper sealing performance is maintained.

In an embodiment, the distance D is between about 10-50 μm, for example about 20 μm.

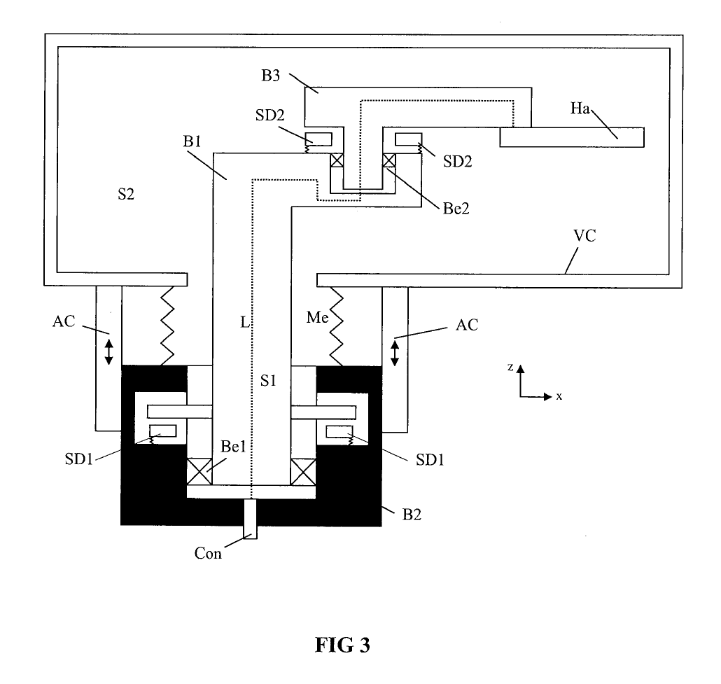

FIG. 3 shows the apparatus 1 of FIG. 2 as described above implemented in a handler to handle an object in a lithographic apparatus in accordance with an embodiment of the invention. A handler may be suitable to handle substrates or reticles. Handling an object may include picking up an object from a receiving station that receives objects from outside the lithographic apparatus, such as from a substrate track, a FOUP or a SMIF. The handler then may place the object onto another station inside the lithographic apparatus, for example a pre-align unit, a substrate table WT or a patterning device support MT.

FIG. 3 depicts body B1 that is connected to body B2 with bearings Be1. Body B1 is rotatable around the z-axis with respect to body B2. Body B2 is connected to a vacuum chamber VC with two actuators AC. The actuators AC are configured to move the body B1 in z-directions relative to the vacuum chamber VC. Membrane Me seals a gap between the vacuum chamber VC and the body B2. Membrane Me is also flexible, so it can compress and expand when body B2 is moved in z-direction with respect to the vacuum chamber VC. Body 3 is connected to body B2 with bearings Be2. Body 3 is rotatable moveable around the z-axis with respect to body B2.

At one side of body B3, handler Ha is connected. Handler Ha is configured to interface with the object that is to be handled.

Space 51 includes the space inside bodies B1, B2 and B3. It also includes the space in which the bearings Be1 and Be2 are located.

Space S2 includes the clean environment for the lithographic process. In this embodiment the pressure in the vacuum chamber VC is about 0.01 mbar.

A seal SD1 according to FIG. 2 is located between bodies B1 and B2. Another seal SD2 is located between bodies B2 and B3. If handler Ha is moveable with respect to body B3, a similar seal may be implemented between the handler Ha and body B3.

As the bodies are made hollow, there is room for cables and wires, schematically indicated by dotted line L. Also driving mechanisms may be placed inside the bodies, such as motors and driving belts. As these components may produce contaminating particle when in use, they are unsuited to use in the clean environment of space S2. As space S1 is sealed from space S2, particles generated inside space S1 does not negatively influence the lithographic process.

This results, for example, in more options for suited cables and hoses. Cables and hoses often have a synthetic or plastic surface and are also often closely packed together to minimize the needed space. Some cables and hoses are connected, for example, to the connector Con on one side, and to the handling device Ha on the other side. These cables and hoses are made moveable so the can follow the movement of the bodies. When the cables and hoses move, they are likely to rub against each other or against another part of the handler. This way, particles are created.

The wires and cables may interface with a component outside the handler through connector Con. This interface may be in an atmospheric pressure.

In an embodiment, the pressure in the first space S1 and the second space S2 may be substantially at an atmospheric pressure. This situation may for example occur during maintenance of the handler or of another part of the lithographic apparatus. The handler or the other part may be located in the second space S2. During this situation, the sealing device SD is pressed onto the first body B1 by the flexible element FE. Alternatively or additionally, another source provides the force to press the sealing device onto the first body B1. For example, this source can be a pressure difference between the first space S1 and the second space S2. Optionally, the fluid supply FS provides a flow to create the distance D. The pressures in the first and second spaces, S1 and S2, are reduced. During this reduction, the pressure in the first space S1 may be maintained at a lower value than the pressure of the second space S2. This helps prevent contaminating particles to move from the first space S1 to the second space S2. When one of the first and second spaces, S1 and S2, reaches its desired pressure, the reduction is stopped in that space. The pressure in the other space is further reduced until the desired pressure is achieved.

In another embodiment, the pressure in the first and second spaces, S1 and S2, is lower than the atmospheric pressure. It may be desirable to have the pressure in the first and second spaces, S1 and S2, equal to the atmospheric pressure, for example for maintenance. When increasing the pressures in the first and second spaces, S1 and S2, the pressure in the first space S1 is maintained at a lower value than the pressure in the second space S2, similar to what is described above.

As will be appreciated, any of the above described features can be used with any other feature and it is not only those combinations explicitly described which are covered in this application.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm). The term “lens”, where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

The controller(s) described herein may each or in combination be operable when the one or more computer programs are read by one or more computer processors located within at least one component of the lithographic apparatus. The controller(s) may each or in combination have any suitable configuration for receiving, processing, and sending signals. One or more processors are configured to communicate with the at least one of the controllers. For example, each controller may include one or more processors for executing the computer programs that include machine-readable instructions for the methods described above. The controller(s) may include data storage medium for storing such computer programs, and/or hardware to receive such medium. So the controller(s) may operate according the machine readable instructions of one or more computer programs.

The descriptions above are intended to be illustrative, not limiting. Thus, it will be apparent to one skilled in the art that modifications may be made to the invention as described without departing from the scope of the claims set out below.

1. An apparatus comprising:
a first body;
a second body that is moveable relative to the first body;
a seal arranged between the first and the second body such that a first space is separated from a second space by the first body, the second body and the seal, wherein the seal is located at a distance from the first body; and
a fluid supply arranged to create a fluid flow between the first body and the seal to create a non-contact seal between the first and the second space so as to enable movement between the first and the second body.

2. The apparatus of claim 1, comprising a controller configured to control the distance during movement of the first and the second body relative to each other.

3. The apparatus of claim 2, comprising a fluid extractor configured to extract at least part of the fluid flow provided between the first body and the seal.

4. The apparatus of claim 3, wherein the controller comprises a flexible element connected between the seal and the second body, the flexible element configured to change the distance in dependency of the fluid flow.

5. The apparatus of claim 4, wherein the flexible element is adjacent to the fluid extractor.

6. The apparatus of claim 4, wherein the fluid extractor is arranged between the second space and the fluid supply.

7. The apparatus of claim 1, wherein the second space comprises less contamination than the first space.

8. The apparatus of claim 1, wherein the first space comprises a bearing configured to at least partly constrain the first body with respect to the second body.

9. The apparatus of claim 1, wherein the first space comprises hydrocarbons.

10. The apparatus of claim 1, wherein the first body is rotatable relative to the second body.

11. The apparatus of claim 1, wherein, in use, the first and second spaces are at a pressure that is lower than the atmospheric pressure.

12. The apparatus of claim 11, wherein, in use, the first space is at a pressure between about 0-30 mbar.

13. The apparatus of claim 11, wherein, in use, the second space is at a pressure of about 0-0.5 mbar.

14. The apparatus of claim 1, wherein the distance D is in the range of about 10-70 μm.

15. The apparatus of claim 1, wherein the fluid flow comprises nitrogen.

16. The apparatus of claim 1, wherein the apparatus is a handler configured to handle an object in a lithographic apparatus.

17. The apparatus of claim 16, wherein the object is a substrate or a patterning device.

18. A lithographic apparatus comprising:
a substrate support configured to hold a substrate;
a projection system configured to project a patterned beam of radiation onto the substrate, and
an apparatus comprising
a first body;
a second body that is moveable relative to the first body;
a seal arranged between the first and the second body such that a first space is separated from a second space by the first body, the second body and the seal, wherein the seal is located at a distance from the first body;
a fluid supply arranged to create a fluid flow between the first body and the seal to create a non-contact seal between the first and the second space so as to enable movement between the first and the second body, and
a controller configured to control the distance during movement of the first and the second body relative to each other.

19. The lithographic apparatus of claim 18, wherein the projection system is arranged in the first space.

20. A method comprising:
providing a first body,
providing a second body that is moveable relative to the first body;
providing a seal arranged between the first and the second body such that a first space is
separated from a second space by the first body, the second body and the seal,
reducing the pressure of the first space and the second space wherein the pressure of the first space is maintained at a lower value than the second space.
